(19) United States
(12) Patent Application Publication
(10) Pub. No.: US 2022/0295574 A1
(43) Pub. Date: Sep. 15, 2022

(54) METHOD AND APPARATUS FOR CHANNEL STATE INFORMATION

(71) Applicant: Telefonaktiebolaget LM Ericsson (publ), Stockholm (SE)

(72) Inventors: Zhipeng LIN, Nanjing (CN); Claes TIDESTAV, Bålsta (SE); Robert Mark HARRISON, Grapevine, TX (US)

(73) Assignee: Telefonaktiebolaget LM Ericsson (publ), Stockholm (SE)

(21) Appl. No.: 17/754,147

(22) PCT Filed: Sep. 2, 2020
(86) PCT No.: PCT/CN2020/113069

§ 371 Date: Mar. 25, 2022

(30) Foreign Application Priority Data
Sep. 27, 2019 (CN) PCT/CN2019/108566

(51) Int. Cl. H04W 74/08; H04W 72/12; H04W 72/14

(52) U.S. Cl. CPC H04W 74/0841; H04W 74/0866; H04W 72/1226; H04W 72/1268; H04W 72/14

(57) ABSTRACT

A method for channel state information. The method which may be performed by a terminal device comprises receiving a channel state information request from a network node. The method further comprises transmitting a channel state information report to the network node in a random access procedure, in response to the channel state information request. The method can be supported in a random access procedure to request and/or report channel state information in a more flexible manner, so that the network performance and transmission efficiency can be improved.

### FIELD OF THE INVENTION

The present disclosure generally relates to communication networks, and more specifically, to a method and apparatus for channel state information.

### BACKGROUND

This section introduces aspects that may facilitate a better understanding of the disclosure. Accordingly, the statements of this section are to be read in this light and are not to be understood as admissions about what is in the prior art or what is not in the prior art.

Communication service providers and network operators have been continually facing challenges to deliver value and convenience to consumers by, for example, providing compelling network services and performance. With the rapid development of networking and communication technologies, wireless communication networks such as long-term evolution (LTE) and new radio (NR) networks are expected to achieve high traffic capacity and end-user data rate with lower latency. In order to connect to a network node, a random access (RA) procedure may be initiated for a terminal device. In the RA procedure, system information (SI) and synchronization signals (SS) as well as the related radio resource and transmission configuration can be informed to the terminal device by signaling information from the network node. The RA procedure can enable the terminal device to establish a session for a specific service with the network node.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

A wireless communication network such as a 5G/NR network may be able to support flexible network configuration. Various signaling approaches (e.g., a four-step approach, a two-step approach, etc.) may be used for a RA procedure of a terminal device to set up a connection with a network node. In a two-step RA procedure, the terminal device can transmit a RA preamble together with the physical uplink shared channel (PUSCH) in a message (which is also known as message A or msgA for short) to the network node, and receive a response message (which is also known as message B or msgB for short) from the network node. The msgA PUSCH can be transmitted in a PUSCH occasion (PO) configured with one or more resource units (RUs), and the RA preamble can be transmitted in a time-frequency physical random access channel (PRACH) occasion (which is also known as a RA occasion or RO for short). In order to implement transmission configuration and resource allocation for the terminal device, the network node may need to know channel conditions of the terminal device. However, in the RA procedure, there may be no dedicated signaling from the network node to inform the terminal device to perform measurements on reference signals and report channel state information (CSI) to the network node. Therefore, it may be desirable to support CSI request/report in a RA procedure.

Various embodiments of the present disclosure propose a solution for CSI, which can enable a terminal device to report the CSI to a network node in a RA procedure (such as a two-step or four-step RA procedure, etc.), e.g., according to a request for the CSI, so as to increase configuration flexibility and improve transmission performance of the RA procedure.

According to a first aspect of the present disclosure, there is provided a method performed by a terminal device such as a user equipment (UE). The method comprises receiving a CSI request from a network node. The method further comprises transmitting a CSI report to the network node in a RA procedure, in response to the CSI request.

In accordance with some exemplary embodiments, the RA procedure may be a two-step RA procedure. According to some exemplary embodiments, the RA procedure may be a four-step RA procedure, or other RA procedure for which it may be needed to support CSI request/report configuration.

In accordance with some exemplary embodiments, the CSI request may be indicated by at least one of:
system information (e.g., some broadcast information or configuration information from the network node, etc.);
radio resource control (RRC) signaling;
downlink control information (DCI);
a response message to PRACH transmission in the RA procedure;
a response message to PUSCH transmission in the RA procedure;
scheduling signaling for uplink (UL) transmission in the RA procedure;
a physical downlink control channel (PDCCH) order; and
a handover command.

In accordance with some exemplary embodiments, the scheduling signaling for UL transmission in the RA procedure may comprise at least one of:
an UL grant for the transmission of the CSI report;
an UL grant for PUSCH transmission; and
an indication of changing from the RA procedure to another RA procedure.

In accordance with some exemplary embodiments, the CSI request may be indicated by an UL grant in a msgB received by the terminal device from the network node in the two-step RA procedure.

In accordance with some exemplary embodiments, the CSI report may be based at least in part on measurement by the terminal device on one or more of:
at least a specific reference signal indicated to the terminal device by the network node;
at least a synchronization signal and physical broadcast channel block (SSB); and
at least a channel state information-reference signal (CSI-RS).

In accordance with some exemplary embodiments, the CSI report may be configured according to at least one of: a handover command from the network node, and a predefined CSI framework.

In accordance with some exemplary embodiments, the CSI report may indicate at least one of:
reference signal received power (RSRP);
reference signal received quality (RSRQ);
signal to interference plus noise ratio (SINR); and
channel quality information (CQI).

In accordance with some exemplary embodiments, the transmission of the CSI report may be performed by the terminal device on at least one of: UL resource scheduled by the network node, and UL resource reserved for PUSCH transmission.

In accordance with some exemplary embodiments, the UL resource scheduled or reserved for PUSCH transmission may comprise UL resource for an initial transmission and/or retransmission of msgA PUSCH.

In accordance with some exemplary embodiments, the UL resource scheduled by the network node may comprise at least one of: UL resource indicated by a response message to PUSCH transmission, and UL resource indicated by DCI.

In accordance with some exemplary embodiments, the transmission of the CSI report may comprise transmitting the CSI report multiplexed with PUSCH. Alternatively or additionally, the transmission of the CSI report may comprise transmitting the CSI report as a part of PUSCH.

According to a second aspect of the present disclosure, there is provided an apparatus which may be implemented as a terminal device. The apparatus comprises one or more processors and one or more memories comprising computer program codes. The one or more memories and the computer program codes are configured to, with the one or more processors, cause the apparatus at least to perform any step of the method according to the first aspect of the present disclosure.

According to a third aspect of the present disclosure, there is provided a computer-readable medium having computer program codes embodied thereon which, when executed on a computer, cause the computer to perform any step of the method according to the first aspect of the present disclosure.

According to a fourth aspect of the present disclosure, there is provided an apparatus which may be implemented as a terminal device. The apparatus may comprise a receiving unit and a transmitting unit. In accordance with some exemplary embodiments, the receiving unit is operable to carry out at least the receiving step in the method according to the first aspect of the present disclosure, and the transmitting unit is operable to carry out at least the transmitting step in the method according to the first aspect of the present disclosure.

According to a fifth aspect of the present disclosure, there is provided a method performed by a network node such as a base station. The method comprises transmitting a CSI request to a terminal device. The method further comprises receiving a CSI report in response to the CSI request, from the terminal device in a RA procedure.

In accordance with some exemplary embodiments, the CSI request may be indicated by an UL grant in a msgB transmitted to the terminal device by the network node in a two-step RA procedure.

In accordance with some exemplary embodiments, the reception of the CSI report may be performed by the network node on at least one of: UL resource scheduled by the network node, and UL resource reserved for PUSCH transmission.

In accordance with some exemplary embodiments, the reception of the CSI report may comprise receiving the CSI report multiplexed with PUSCH. Alternatively or additionally, the reception of the CSI report may comprise receiving the CSI report as a part of PUSCH.

According to a sixth aspect of the present disclosure, there is provided an apparatus which may be implemented as a network node. The apparatus comprises one or more processors and one or more memories comprising computer program codes. The one or more memories and the computer program codes are configured to, with the one or more processors, cause the apparatus at least to perform any step of the method according to the fifth aspect of the present disclosure.

According to a seventh aspect of the present disclosure, there is provided a computer-readable medium having computer program codes embodied thereon which, when executed on a computer, cause the computer to perform any step of the method according to the fifth aspect of the present disclosure.

According to an eighth aspect of the present disclosure, there is provided an apparatus which may be implemented as a network node. The apparatus may comprise a transmitting unit and a receiving unit. In accordance with some exemplary embodiments, the transmitting unit is operable to carry out at least the transmitting step in the method according to the fifth aspect of the present disclosure, and the receiving unit is operable to carry out at least the receiving step in the method according to the fifth aspect of the present disclosure.

### BRIEF DESCRIPTION OF THE DRAWINGS

The disclosure itself, the preferable mode of use and further objectives are best understood by reference to the following detailed description of the embodiments when read in conjunction with the accompanying drawings, in which:

FIG. 1 is a diagram illustrating an exemplary four-step RA procedure according to an embodiment of the present disclosure;

FIG. 2 is a diagram illustrating an exemplary two-step RA procedure according to an embodiment of the present disclosure;

FIG. 3 is a flowchart illustrating a method according to some embodiments of the present disclosure;

FIG. 4 is a flowchart illustrating another method according to some embodiments of the present disclosure;

FIG. 5 is a block diagram illustrating an apparatus according to some embodiments of the present disclosure;

FIG. 6A is a block diagram illustrating another apparatus according to some embodiments of the present disclosure;

FIG. 6B is a block diagram illustrating yet another apparatus according to some embodiments of the present disclosure;

FIG. 7 is a block diagram illustrating a telecommunication network connected via an intermediate network to a host computer in accordance with some embodiments of the present disclosure;

FIG. 8 is a block diagram illustrating a host computer communicating via a base station with a UE over a partially wireless connection in accordance with some embodiments of the present disclosure;

FIG. 9 is a flowchart illustrating a method implemented in a communication system, in accordance with an embodiment of the present disclosure;

FIG. 10 is a flowchart illustrating a method implemented in a communication system, in accordance with an embodiment of the present disclosure;

FIG. 11 is a flowchart illustrating a method implemented in a communication system, in accordance with an embodiment of the present disclosure; and

FIG. 12 is a flowchart illustrating a method implemented in a communication system, in accordance with an embodiment of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “communication network” refers to a network following any suitable communication standards, such as new radio (NR), long term evolution (LTE), LTE-Advanced, wideband code division multiple access (WCDMA), high-speed packet access (HSPA), and so on. Furthermore, the communications between a terminal device and a network node in the communication network may be performed according to any suitable generation communication protocols, including, but not limited to, the first generation (1G), the second generation (2G), 2.5G, 2.75G, the third generation (3G), 4G, 4.5G, 5G communication protocols, and/or any other protocols either currently known or to be developed in the future.

The term “network node” refers to a network device in a communication network via which a terminal device accesses to the network and receives services therefrom. The network node may refer to a base station (BS), an access point (AP), a multi-cell/multicast coordination entity (MCE), a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

Yet further examples of the network node comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network node may represent any suitable device (or group of devices) capable, configured, arranged, and/or operable to enable and/or provide a terminal device access to a wireless communication network or to provide some service to a terminal device that has accessed to the wireless communication network.

The term “terminal device” refers to any end device that can access a communication network and receive services therefrom. By way of example and not limitation, the terminal device may refer to a mobile terminal, a user equipment (UE), or other suitable devices. The UE may be, for example, a subscriber station, a portable subscriber station, a mobile station (MS) or an access terminal (AT). The terminal device may include, but not limited to, portable computers, image capture terminal devices such as digital cameras, gaming terminal devices, music storage and playback appliances, a mobile phone, a cellular phone, a smart phone, a tablet, a wearable device, a personal digital assistant (PDA), a vehicle, and the like.

As yet another specific example, in an Internet of things (IoT) scenario, a terminal device may also be called an IoT device and represent a machine or other device that performs monitoring, sensing and/or measurements etc., and transmits the results of such monitoring, sensing and/or measurements etc. to another terminal device and/or a network equipment. The terminal device may in this case be a machine-to-machine (M2M) device, which may in a 3rd generation partnership project (3GPP) context be referred to as a machine-type communication (MTC) device.

As one particular example, the terminal device may be a UE implementing the 3GPP narrow band Internet of things (NB-IoT) standard. Particular examples of such machines or devices are sensors, metering devices such as power meters, industrial machinery, or home or personal appliances, e.g. refrigerators, televisions, personal wearables such as watches etc. In other scenarios, a terminal device may represent a vehicle or other equipment, for example, a medical instrument that is capable of monitoring, sensing and/or reporting etc. on its operational status or other functions associated with its operation.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

Wireless communication networks are widely deployed to provide various telecommunication services such as voice, video, data, messaging and broadcasts. As described previously, in order to connect to a network node such as a gNB in a wireless communication network, a terminal device such as a UE may need to perform a RA procedure to exchange essential information and messages for communication link establishment with the network node.

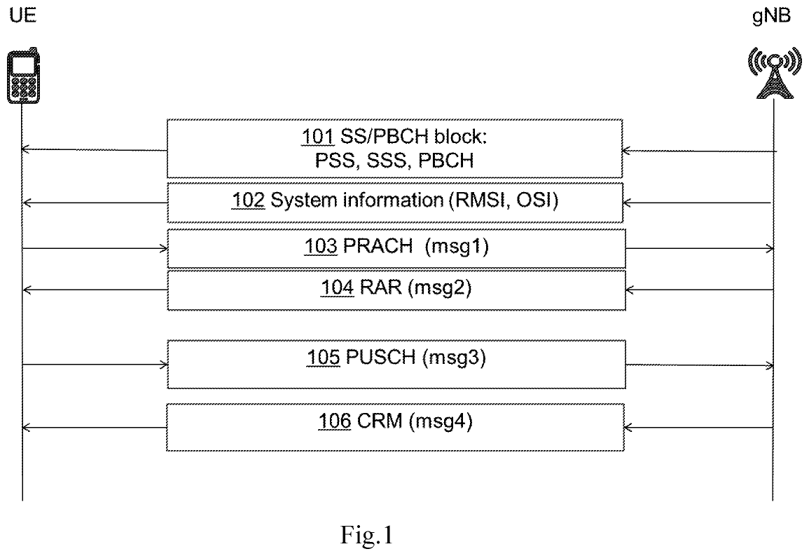

FIG. 1 is a diagram illustrating an exemplary four-step RA procedure according to an embodiment of the present disclosure. As shown in FIG. 1, a UE can detect a synchronization signal (SS) by receiving 101 a synchronization signal and physical broadcast channel block (which is also known as a SS/PBCH block or SSB for short) from a gNB, for example, including a primary synchronization signal (PSS), a secondary synchronization signal (SSS), and a physical broadcast channel (PBCH). The UE can decode 102 some system information (e.g., remaining minimum system information (RMSI) and other system information (OSI)) broadcasted in the downlink (DL). Then the UE can transmit 103 a PRACH preamble (message1/msg1) in the uplink (UL). The gNB can reply 104 with a random access response (RAR, message2/msg2). In response to the RAR from the gNB, the UE can transmit 105 the UE's identification information (message3/msg3) on PUSCH. Then the gNB can send 106 a contention resolution message (CRM, message4/msg4) to the UE. In some cases, the PRACH preamble (message1/msg1) may be reattempted by the UE and different preambles can be selected for the initial transmission and its subsequent retransmission(s).

In the exemplary procedure shown in FIG. 1, the UE can transmit message3/msg3 on PUSCH after receiving a timing advance command in the RAR, allowing message3/msg3 on PUSCH to be received with timing accuracy within a cyclic prefix (CP). Without this timing advance, a very large CP may be needed in order to be able to demodulate and detect message3/msg3 on PUSCH, unless the communication system is applied in a cell with very small distance between the UE and the gNB. Since a NR system can also support larger cells with a need for providing a timing advance command to the UE, the four-step approach is needed for the RA procedure.

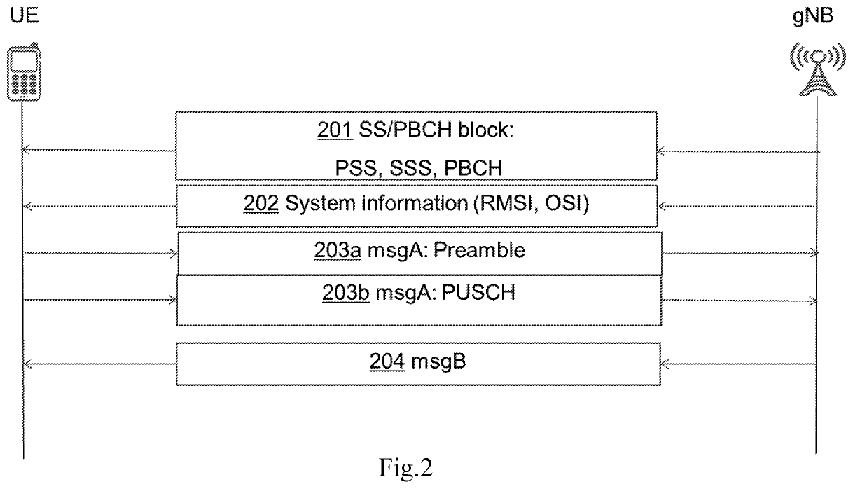

FIG. 2 is a diagram illustrating an exemplary two-step RA procedure according to an embodiment of the present disclosure. Similar to the procedure as shown in FIG. 1, in the procedure shown in FIG. 2, a UE can detect a SS by receiving 201 an SS/PBCH block (e.g., comprising PSS, SSS and PBCH) from a gNB, and decode 202 system information (e.g., comprising RMSI and OSI) broadcasted in the DL. Compared to the four-step RA procedure as shown in FIG. 1, the UE performing the procedure in FIG. 2 can complete RA in only two steps. Firstly, the UE sends 203a/203b to the gNB a message A (msgA) including RA preamble together with higher layer data such as a radio resource control (RRC) connection request possibly with some payload on PUSCH. Secondly, the gNB sends 204 to the UE a RAR (also called message B or msgB) including UE identifier assignment, timing advance information, a contention resolution message, and etc.

In the four-step RA procedure as illustrated in FIG. 1, the gNB may transmit a RAR message to the UE, for example, in response to reception of msg1. According to an exemplary embodiment, the gNB may include a CSI request in the RAR message, for example, by using a bit reserved for that purpose. It may be needed to describe how to use this bit. Optionally, a CSI request field may be introduced (e.g., as defined for NB-IoT in LTE) with the purpose to aid the physical downlink control channel (PDCCH) link adaptation. According to another exemplary embodiment, the UE can provide the gNB with a CSI report in msg3.

In the two-step RA procedure as shown in FIG. 2, the msgA preamble and msgA PUSCH (also called msgA payload) can be transmitted by the UE in one message called message A (or msgA for short). For the initial transmission of msgA, there may be no dedicated signaling from the gNB to inform the UE to start measurement on some reference signals and report the related CSI in UL transmission (e.g., the msgA PUSCH) to the gNB. Therefore, it may be needed to provide a solution for requesting and/or reporting CSI of the UE in the RA procedure.

Various exemplary embodiments of the present disclosure propose a solution for supporting CSI request/report in a RA procedure such as a two-step or four-step RA procedure. According to the proposed solution, a CSI request from a network node such as a gNB can be informed to a UE via a specific signaling, and the UE can make a response to the CSI request by performing measurement on some reference signals and sending a CSI report to the network node via a UL channel for the RA procedure. By applying the proposed solution, the network node can obtain specific CSI of the UE in the RA procedure, so as to enhance efficiency of resource allocation and improve flexibility of transmission scheduling. It can be appreciated that although some embodiments of the present disclosure are mainly described in context of the two-step RA procedure, the proposed solution may also be applicable to other RA procedures for which the definition and configuration of CSI request/report may be unavailable or incomplete.

In accordance with some exemplary embodiments, a UE can determine or detect a CSI request from network side, for example, by cell-specific signaling in system information (e.g., in system information block 1 (SIB1)), by msgB received in a RA procedure (e.g., if there is any msgA PUSCH retransmission, alternatively or additionally, if there is also an UL grant in msgB for an UL transmission of the CSI), and/or by a PDCCH order, etc.

In accordance with some exemplary embodiments, the UE can determine specific reference signals used for the CSI report generation, in response to the CSI request. The specific reference signals may be provided or indicated to the UE, for example, via system information. Alternatively or additionally, the UE can determine one or more SSBs as reference signals to be measured, according to certain CSI report configuration. The UE may generate a CSI report based at least in part on the measurement on the determined reference signals.

In accordance with some exemplary embodiments, the UE may send the CSI report via UL transmission to the network node. For example, the CSI report may be included into the initial transmission and/or retransmission(s) of msgA PUSCH. Alternatively or additionally, the CSI report may be included in some uplink control information (UCI) multiplexed with PUSCH or be a field of the PUSCH. Optionally, the CSI report may be sent to the network node on an UL channel scheduled by a response message such as msgB received from the network node by the UE.

In accordance with some exemplary embodiments, the content in the CSI report may comprise physical layer-reference signal received power/reference signal received quality (L1-RSRP/RSRQ), physical layer-signal to interference plus noise ratio (L1-SINR), channel quality information (CQI), etc. Optionally, in the case that the CSI report is generated by the UE after reception of a handover command, the content in the CSI report may be configured based at least in part on the handover command.

It is noted that some embodiments of the present disclosure are mainly described in relation to 5G or NR specifications being used as non-limiting examples for certain exemplary network configurations and system deployments. As such, the description of exemplary embodiments given herein specifically refers to terminology which is directly related thereto. Such terminology is only used in the context of the presented non-limiting examples and embodiments, and does naturally not limit the present disclosure in any way. Rather, any other system configuration or radio technologies may equally be utilized as long as exemplary embodiments described herein are applicable.

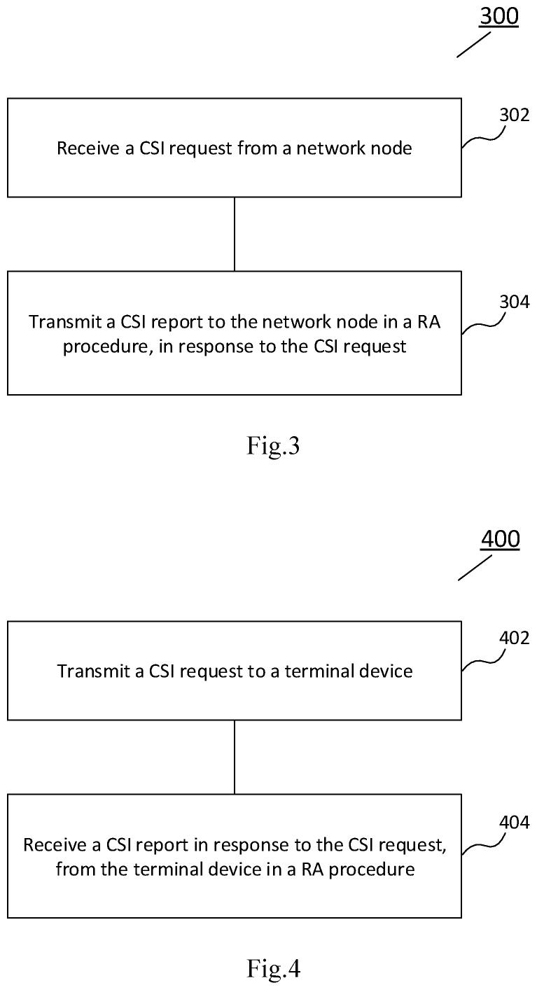

FIG. 3 is a flowchart illustrating a method 300 according to some embodiments of the present disclosure. The method 300 illustrated in FIG. 3 may be performed by a terminal device or an apparatus communicatively coupled to the terminal device. In accordance with an exemplary embodiment, the terminal device such as a UE may be configurable to connect to a network node such as a gNB, for example, by performing a RA procedure (e.g., a two-step or four-step RA procedure).

According to the exemplary method 300 illustrated in FIG. 3, the terminal device can receive a CSI request from a network node, as shown in block 302. In response to the CSI request, the terminal device can transmit a CSI report to the network node in a RA procedure, as shown in block 304. The RA procedure may be a two-step RA procedure or other RA procedures for which the CSI request/report configuration may be implemented according to some exemplary embodiments of the present disclosure. It can be appreciated that the terminal device may receive the CSI request prior to or during the RA procedure, depending on specific network configuration.

In accordance with some exemplary embodiments, the CSI request may be indicated by at least one of:
system information (e.g., SIB1 or any other suitable higher layer signaling carrying system information);
RRC signaling;
downlink control information (DCI);
a response message to PRACH transmission in the RA procedure (e.g., msgB or any other suitable response message to msgA PRACH);
a response message to PUSCH transmission in the RA procedure (e.g., msgB or any other suitable response message to msgA PUSCH);
scheduling signaling for UL transmission in the RA procedure (e.g., UL grant or any other suitable signaling in a response message to msgA PUSCH);
a PDCCH order; and
a handover command.

In accordance with some exemplary embodiments, the CSI request may be transmitted via higher layer signaling, such as a system information message and/or the dedicated signaling. The system information message can be e.g. SIB1 from the network node. Optionally, the CSI request in the system information message can be overwritten by the dedicated signaling (e.g., RRC signaling) which may be mainly used when a UE is in RRC connected mode.

In accordance with some exemplary embodiments, the CSI request may be transmitted via L1 signaling which can be included in the DCI format for the retransmission of msgA PUSCH (if supported). For example, the CSI request may be indicated by one or more specific bits in the DCI from the network node.

In accordance with some exemplary embodiments, the CSI request may be explicitly indicated in the response message to the msgA PRACH and/or msgA PUSCH transmission of a UE, e.g., in the msgB physical downlink shared channel (PDSCH) from a gNB. In accordance with some exemplary embodiments, the CSI request may be implicitly indicated by some specific signaling (e.g., scheduling signaling for UL transmission) in the response message to the msgA PRACH and/or msgA PUSCH transmission of the UE. In response to reception of such specific signaling from the gNB, the UE can be aware of that certain CSI may be requested by the gNB.

In accordance with some exemplary embodiments, the scheduling signaling for UL transmission in the RA procedure may comprise at least one of:
an UL grant for the transmission of the CSI report;
an UL grant for PUSCH transmission (e.g., the retransmission of msgA PUSCH, etc.); and
an indication of changing from the RA procedure to another RA procedure (e.g., a fallback indication which can instruct a UE to fallback to a four-step RA procedure from a two-step RA procedure).

In accordance with some exemplary embodiments, the CSI request may be indicated by, e.g., one or more bits reserved in an UL grant in a message B/msgB received by the terminal device from the network node in the two-step RA procedure.

In accordance with some exemplary embodiments, the CSI request may be indicated via a PDCCH order (e.g., a PDCCH order in the DCI for triggering a two-step RA procedure). Alternatively or additionally, the CSI request may be indicated via a handover command prior to the two-step RA procedure.

In accordance with some exemplary embodiments, some channel measurement by the terminal device may be triggered in response to the CSI request, and the terminal device can generate the CSI report according to the channel measurement (e.g., the measurement on DL reference signals). In some exemplary embodiments, the CSI report may be based at least in part on measurement by the terminal device such as a UE on one or more of:
at least a specific reference signal indicated to the terminal device by the network node (e.g., a reference signal provided/indicated to the UE from the network side via system information and/or dedicated RRC signaling);
at least an SSB (e.g. the best SSB detected by the UE, a set of SSBs determined by the UE according to a specific rule, etc.); and
at least a channel state information-reference signal (CSI-RS).

In accordance with some exemplary embodiments, the CSI report may be configured according to a handover command from the network node and/or a predefined CSI framework. In an exemplary embodiment, the CSI report configuration may be signaled in the handover command prior to the RA procedure. The handover command may trigger the RA procedure (e.g., the two-step RA procedure) for the terminal device. In another exemplary embodiment, the CSI report configuration may be determined according to the predefined CSI framework such as a CSI framework as defined in section 5.2.1 of 3GPP TS 38.214 V15.6.0. Optionally, the predefined CSI framework may comprise reporting settings, resource settings, reporting configurations (e.g., resource setting configuration, report quantity configurations, L1-RSRP reporting, etc.). According to some embodiments, the CSI report configuration may indicate one or more reference signals to be measured, how to calculate or derive CSI according to the measurement on the reference signals, how to generate and/or transmit the CSI report, etc.

In accordance with some exemplary embodiments, the CSI report may indicate RSRP, RSRQ, SINR and/or CQI, etc. According to an exemplary embodiment, the CSI report may include L1-RSRP, L1-RSRQ, L1-SINR and/or CQI measured on the specific DL reference signals, etc.

In accordance with some exemplary embodiments, the transmission of the CSI report may be performed on UL resource scheduled by the network node and/or UL resource reserved for PUSCH transmission (e.g., including the initial PUSCH transmission and/or the potential PUSCH retransmission(s)). The UL resource may comprise a channel (e.g., PUSCH, PUCCH or any other suitable channel using specific time-frequency domain resource) allocated for the UL transmission of the terminal device. According to some exemplary embodiments, the UL resource scheduled by the network node may comprise UL resource indicated by a response message to PUSCH transmission, and/or UL resource indicated by DCI. For example, the CSI report may be transmitted on the channel scheduled by the response message such as msgB from the network node. According to some embodiments, the CSI report may be transmitted in an initial transmission and/or retransmission of msgA PUSCH on the PUSCH resources reserved for the msgA PUSCH transmission(s). In the case that the CSI report is transmitted in the retransmission(s) of the msgA PUSCH, the CSI report may be transmitted via a configured grant or dynamic grant provided by the network node.

In accordance with some exemplary embodiments, the transmission of the CSI report may comprise transmitting the CSI report multiplexed with PUSCH (e.g., msgA PUSCH). Alternatively or additionally, the transmission of the CSI report may comprise transmitting the CSI report as a part of PUSCH (e.g., within the msgA PUSCH content). For example, one or multiple parts of CSI may be determined for the CSI report. In the case that the CSI report is multiplexed with the msgA PUSCH, various offset values may be introduced for different CSI parts, and the offset values may be signaled via RRC signaling or predetermined. If acknowledgement/negative acknowledgement (ACK/NACK) is also multiplexed on the same UL channel, the corresponding offset of ACK/NACK may also be signaled via RRC signaling or predetermined. Optionally, in the case that the offset values are not signaled to the terminal device by the network node, default values may be defined and used correspondingly.

FIG. 4 is a flowchart illustrating a method 400 according to some embodiments of the present disclosure. The method 400 illustrated in FIG. 4 may be performed by a network node or an apparatus communicatively coupled to the network node. In accordance with an exemplary embodiment, the network node may comprise a base station such as a gNB. The network node may be configurable to communicate with one or more terminal devices such as UEs which can connect to the network node by performing a RA procedure (e.g., a two-step or four-step RA procedure).

According to the exemplary method 400 illustrated in FIG. 4, the network node can transmit a CSI request to a terminal device (e.g., the terminal device as described with respect to FIG. 3), as shown in block 402. In accordance with some exemplary embodiments, the network node can receive a CSI report in response to the CSI request, from the terminal device in a RA procedure, as shown in block 404. As described with respect to FIG. 3, the RA procedure may be a two-step RA procedure or other RA procedures for which the CSI request/report configuration may be implemented according to some exemplary embodiments of the present disclosure.

It can be appreciated that the steps, operations and related settings of the method 400 illustrated in FIG. 4 may be correspond to the steps, operations and related settings of the method 300 illustrated in FIG. 3. It also can be appreciated that the configuration and contents of the CSI request/report as described with respect to FIG. 4 may correspond to the configuration and contents of the CSI request/report as described with respect to FIG. 3, respectively. According to an exemplary embodiment, the CSI request transmitted by the network node as described in connection with FIG. 4 may be the CSI request received by the terminal device as described in connection with FIG. 3. Similarly, the CSI report transmitted by the terminal device as described in connection with FIG. 3 may be the CSI report received by the network node as described in connection with FIG. 4.

In accordance with some exemplary embodiments, the CSI request may be indicated by an UL grant in a message B/msgB transmitted to the terminal device by the network node in the two-step RA procedure.

In accordance with some exemplary embodiments, the reception of the CSI report may be performed by the network node on UL resource scheduled by the network node (e.g., via DCI, msgB or other response message), and/or UL resource reserved for PUSCH transmission (e.g., an initial transmission and/or retransmission(s) of msgA PUSCH).

In accordance with some exemplary embodiments, the reception of the CSI report by the network node may comprise receiving the CSI report multiplexed with PUSCH from the terminal device. Alternatively or additionally, the reception of the CSI report by the network node may comprise receiving the CSI report as a part of PUSCH from the terminal device.

The proposed solution according to one or more exemplary embodiments can enable a terminal device to report the CSI based on specific reference signal measurement to a network node in a RA procedure (e.g., a two-step RA procedure or other proper RA procedures), in response to a CSI request from the network node. Application of some exemplary embodiments can implement support of CSI requesting and/or reporting in a RA procedure in a more flexible and efficient manner.

The various blocks shown in FIGS. 3-4 may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

FIG. 5 is a block diagram illustrating an apparatus 500 according to various embodiments of the present disclosure. As shown in FIG. 5, the apparatus 500 may comprise one or more processors such as processor 501 and one or more memories such as memory 502 storing computer program codes 503. The memory 502 may be non-transitory machine/processor/computer readable storage medium. In accordance with some exemplary embodiments, the apparatus 500 may be implemented as an integrated circuit chip or module that can be plugged or installed into a terminal device as described with respect to FIG. 3, or a network node as described with respect to FIG. 4. In such case, the apparatus 500 may be implemented as a terminal device as described with respect to FIG. 3, or a network node as described with respect to FIG. 4.

In some implementations, the one or more memories 502 and the computer program codes 503 may be configured to, with the one or more processors 501, cause the apparatus 500 at least to perform any operation of the method as described in connection with FIG. 3. In other implementations, the one or more memories 502 and the computer program codes 503 may be configured to, with the one or more processors 501, cause the apparatus 500 at least to perform any operation of the method as described in connection with FIG. 4. Alternatively or additionally, the one or more memories 502 and the computer program codes 503 may be configured to, with the one or more processors 501, cause the apparatus 500 at least to perform more or less operations to implement the proposed methods according to the exemplary embodiments of the present disclosure.

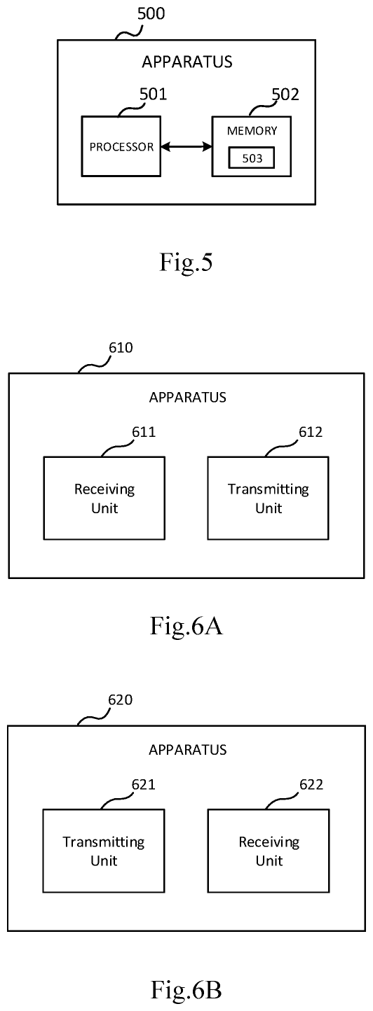

FIG. 6A is a block diagram illustrating an apparatus 610 according to some embodiments of the present disclosure. As shown in FIG. 6A, the apparatus 610 may comprise a receiving unit 611 and a transmitting unit 612. In an exemplary embodiment, the apparatus 610 may be implemented in a terminal device such as a UE. The receiving unit 611 may be operable to carry out the operation in block 302, and the transmitting unit 612 may be operable to carry out the operation in block 304. Optionally, the receiving unit 611 and/or the transmitting unit 612 may be operable to carry out more or less operations to implement the proposed methods according to the exemplary embodiments of the present disclosure.

FIG. 6B is a block diagram illustrating an apparatus 620 according to some embodiments of the present disclosure. As shown in FIG. 6B, the apparatus 620 may comprise a transmitting unit 621 and a receiving unit 622. In an exemplary embodiment, the apparatus 620 may be implemented in a network node such as a base station. The transmitting unit 621 may be operable to carry out the operation in block 402, and the receiving unit 622 may be operable to carry out the operation in block 404. Optionally, the transmitting unit 621 and/or the receiving unit 622 may be operable to carry out more or less operations to implement the proposed methods according to the exemplary embodiments of the present disclosure.

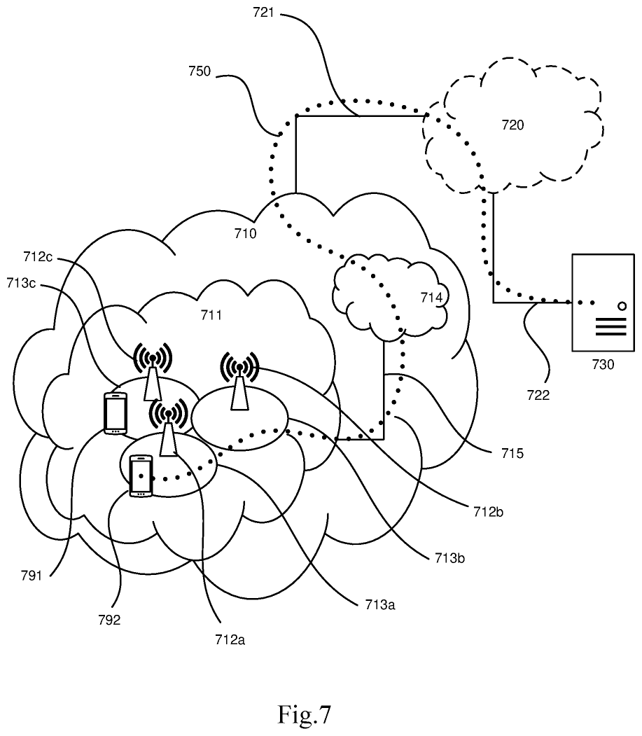

FIG. 7 is a block diagram illustrating a telecommunication network connected via an intermediate network to a host computer in accordance with some embodiments of the present disclosure.

With reference to FIG. 7, in accordance with an embodiment, a communication system includes a telecommunication network 710, such as a 3GPP-type cellular network, which comprises an access network 711, such as a radio access network, and a core network 714. The access network 711 comprises a plurality of base stations 712a, 712b, 712c, such as NBs, eNBs, gNBs or other types of wireless access points, each defining a corresponding coverage area 713a, 713b, 713c. Each base station 712a, 712b, 712c is connectable to the core network 714 over a wired or wireless connection 715. A first UE 791 located in a coverage area 713c is configured to wirelessly connect to, or be paged by, the corresponding base station 712c. A second UE 792 in a coverage area 713a is wirelessly connectable to the corresponding base station 712a. While a plurality of UEs 791, 792 are illustrated in this example, the disclosed embodiments are equally applicable to a situation where a sole UE is in the coverage area or where a sole UE is connecting to the corresponding base station 712.

The telecommunication network 710 is itself connected to a host computer 730, which may be embodied in the hardware and/or software of a standalone server, a cloud-implemented server, a distributed server or as processing resources in a server farm. The host computer 730 may be under the ownership or control of a service provider, or may be operated by the service provider or on behalf of the service provider. Connections 721 and 722 between the telecommunication network 710 and the host computer 730 may extend directly from the core network 714 to the host computer 730 or may go via an optional intermediate network 720. An intermediate network 720 may be one of, or a combination of more than one of, a public, private or hosted network; the intermediate network 720, if any, may be a backbone network or the Internet; in particular, the intermediate network 720 may comprise two or more sub-networks (not shown).

The communication system of FIG. 7 as a whole enables connectivity between the connected UEs 791, 792 and the host computer 730. The connectivity may be described as an over-the-top (OTT) connection 750. The host computer 730 and the connected UEs 791, 792 are configured to communicate data and/or signaling via the OTT connection 750, using the access network 711, the core network 714, any intermediate network 720 and possible further infrastructure (not shown) as intermediaries. The OTT connection 750 may be transparent in the sense that the participating communication devices through which the OTT connection 750 passes are unaware of routing of uplink and downlink communications. For example, the base station 712 may not or need not be informed about the past routing of an incoming downlink communication with data originating from the host computer 730 to be forwarded (e.g., handed over) to a connected UE 791. Similarly, the base station 712 need not be aware of the future routing of an outgoing uplink communication originating from the UE 791 towards the host computer 730.

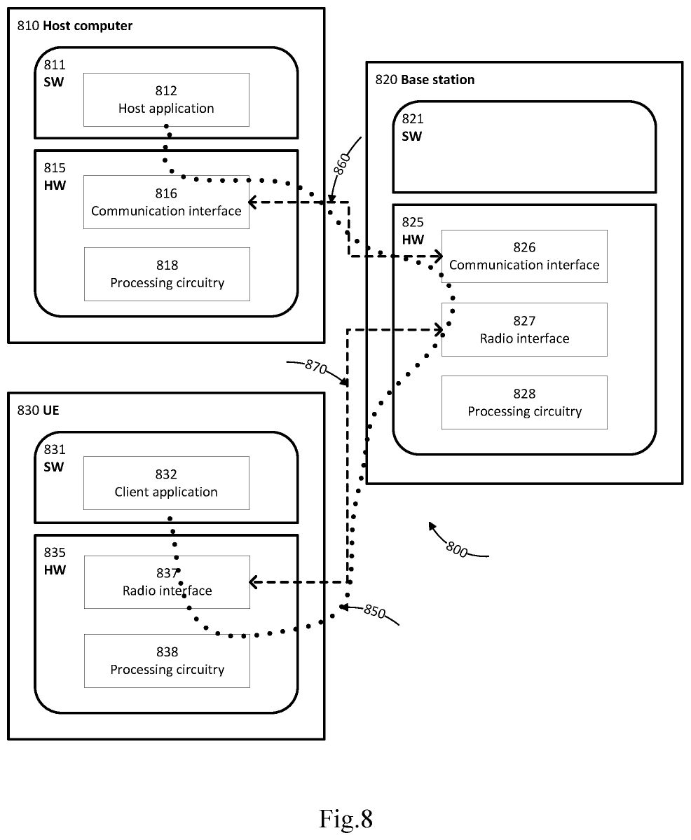

FIG. 8 is a block diagram illustrating a host computer communicating via a base station with a UE over a partially wireless connection in accordance with some embodiments of the present disclosure.

Example implementations, in accordance with an embodiment, of the UE, base station and host computer discussed in the preceding paragraphs will now be described with reference to FIG. 8. In a communication system 800, a host computer 810 comprises hardware 815 including a communication interface 816 configured to set up and maintain a wired or wireless connection with an interface of a different communication device of the communication system 800. The host computer 810 further comprises a processing circuitry 818, which may have storage and/or processing capabilities. In particular, the processing circuitry 818 may comprise one or more programmable processors, application-specific integrated circuits, field programmable gate arrays or combinations of these (not shown) adapted to execute instructions. The host computer 810 further comprises software 811, which is stored in or accessible by the host computer 810 and executable by the processing circuitry 818. The software 811 includes a host application 812. The host application 812 may be operable to provide a service to a remote user, such as UE 830 connecting via an OTT connection 850 terminating at the UE 830 and the host computer 810. In providing the service to the remote user, the host application 812 may provide user data which is transmitted using the OTT connection 850.

The communication system 800 further includes a base station 820 provided in a telecommunication system and comprising hardware 825 enabling it to communicate with the host computer 810 and with the UE 830. The hardware 825 may include a communication interface 826 for setting up and maintaining a wired or wireless connection with an interface of a different communication device of the communication system 800, as well as a radio interface 827 for setting up and maintaining at least a wireless connection 870 with the UE 830 located in a coverage area (not shown in FIG. 8) served by the base station 820. The communication interface 826 may be configured to facilitate a connection 860 to the host computer 810. The connection 860 may be direct or it may pass through a core network (not shown in FIG. 8) of the telecommunication system and/or through one or more intermediate networks outside the telecommunication system. In the embodiment shown, the hardware 825 of the base station 820 further includes a processing circuitry 828, which may comprise one or more programmable processors, application-specific integrated circuits, field programmable gate arrays or combinations of these (not shown) adapted to execute instructions. The base station 820 further has software 821 stored internally or accessible via an external connection.

The communication system 800 further includes the UE 830 already referred to. Its hardware 835 may include a radio interface 837 configured to set up and maintain a wireless connection 870 with a base station serving a coverage area in which the UE 830 is currently located. The hardware 835 of the UE 830 further includes a processing circuitry 838, which may comprise one or more programmable processors, application-specific integrated circuits, field programmable gate arrays or combinations of these (not shown) adapted to execute instructions. The UE 830 further comprises software 831, which is stored in or accessible by the UE 830 and executable by the processing circuitry 838. The software 831 includes a client application 832. The client application 832 may be operable to provide a service to a human or non-human user via the UE 830, with the support of the host computer 810. In the host computer 810, an executing host application 812 may communicate with the executing client application 832 via the OTT connection 850 terminating at the UE 830 and the host computer 810. In providing the service to the user, the client application 832 may receive request data from the host application 812 and provide user data in response to the request data. The OTT connection 850 may transfer both the request data and the user data. The client application 832 may interact with the user to generate the user data that it provides.

It is noted that the host computer 810, the base station 820 and the UE 830 illustrated in FIG. 8 may be similar or identical to the host computer 730, one of base stations 712a, 712b, 712c and one of UEs 791, 792 of FIG. 7, respectively. This is to say, the inner workings of these entities may be as shown in FIG. 8 and independently, the surrounding network topology may be that of FIG. 7.

In FIG. 8, the OTT connection 850 has been drawn abstractly to illustrate the communication between the host computer 810 and the UE 830 via the base station 820, without explicit reference to any intermediary devices and the precise routing of messages via these devices. Network infrastructure may determine the routing, which it may be configured to hide from the UE 830 or from the service provider operating the host computer 810, or both. While the OTT connection 850 is active, the network infrastructure may further take decisions by which it dynamically changes the routing (e.g., on the basis of load balancing consideration or reconfiguration of the network).

Wireless connection 870 between the UE 830 and the base station 820 is in accordance with the teachings of the embodiments described throughout this disclosure. One or more of the various embodiments improve the performance of OTT services provided to the UE 830 using the OTT connection 850, in which the wireless connection 870 forms the last segment. More precisely, the teachings of these embodiments may improve the latency and the power consumption, and thereby provide benefits such as lower complexity, reduced time required to access a cell, better responsiveness, extended battery lifetime, etc.

A measurement procedure may be provided for the purpose of monitoring data rate, latency and other factors on which the one or more embodiments improve. There may further be an optional network functionality for reconfiguring the OTT connection 850 between the host computer 810 and the UE 830, in response to variations in the measurement results. The measurement procedure and/or the network functionality for reconfiguring the OTT connection 850 may be implemented in software 811 and hardware 815 of the host computer 810 or in software 831 and hardware 835 of the UE 830, or both. In embodiments, sensors (not shown) may be deployed in or in association with communication devices through which the OTT connection 850 passes; the sensors may participate in the measurement procedure by supplying values of the monitored quantities exemplified above, or supplying values of other physical quantities from which the software 811, 831 may compute or estimate the monitored quantities. The reconfiguring of the OTT connection 850 may include message format, retransmission settings, preferred routing etc.; the reconfiguring need not affect the base station 820, and it may be unknown or imperceptible to the base station 820. Such procedures and functionalities may be known and practiced in the art. In certain embodiments, measurements may involve proprietary UE signaling facilitating the host computer 810's measurements of throughput, propagation times, latency and the like. The measurements may be implemented in that the software 811 and 831 causes messages to be transmitted, in particular empty or ‘dummy’ messages, using the OTT connection 850 while it monitors propagation times, errors etc.

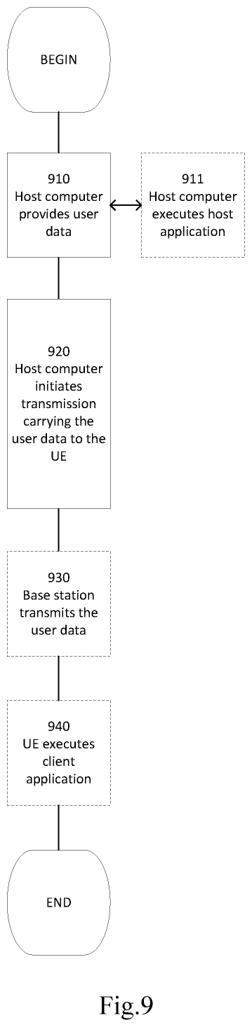

FIG. 9 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 9 will be included in this section. In step 910, the host computer provides user data. In substep 911 (which may be optional) of step 910, the host computer provides the user data by executing a host application. In step 920, the host computer initiates a transmission carrying the user data to the UE. In step 930 (which may be optional), the base station transmits to the UE the user data which was carried in the transmission that the host computer initiated, in accordance with the teachings of the embodiments described throughout this disclosure. In step 940 (which may also be optional), the UE executes a client application associated with the host application executed by the host computer.

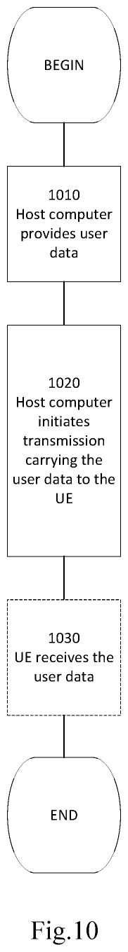

FIG. 10 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 10 will be included in this section. In step 1010 of the method, the host computer provides user data. In an optional substep (not shown) the host computer provides the user data by executing a host application. In step 1020, the host computer initiates a transmission carrying the user data to the UE. The transmission may pass via the base station, in accordance with the teachings of the embodiments described throughout this disclosure. In step 1030 (which may be optional), the UE receives the user data carried in the transmission.

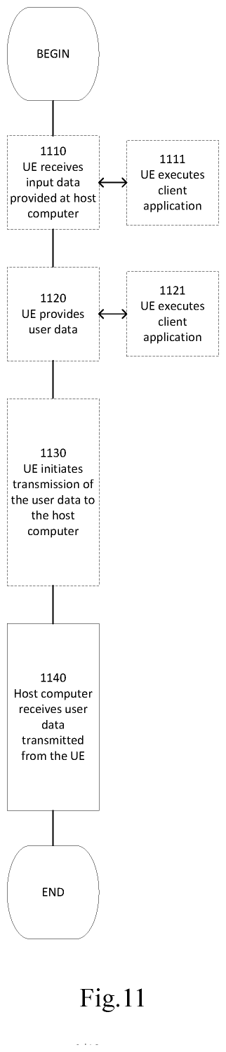

FIG. 11 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 11 will be included in this section. In step 1110 (which may be optional), the UE receives input data provided by the host computer. Additionally or alternatively, in step 1120, the UE provides user data. In substep 1121 (which may be optional) of step 1120, the UE provides the user data by executing a client application. In substep 1111 (which may be optional) of step 1110, the UE executes a client application which provides the user data in reaction to the received input data provided by the host computer. In providing the user data, the executed client application may further consider user input received from the user. Regardless of the specific manner in which the user data was provided, the UE initiates, in substep 1130 (which may be optional), transmission of the user data to the host computer. In step 1140 of the method, the host computer receives the user data transmitted from the UE, in accordance with the teachings of the embodiments described throughout this disclosure.

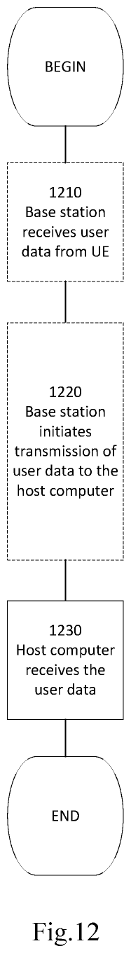

FIG. 12 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 12 will be included in this section. In step 1210 (which may be optional), in accordance with the teachings of the embodiments described throughout this disclosure, the base station receives user data from the UE. In step 1220 (which may be optional), the base station initiates transmission of the received user data to the host computer. In step 1230 (which may be optional), the host computer receives the user data carried in the transmission initiated by the base station.

According to some exemplary embodiments, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station which may perform any step of the exemplary method 400 as describe with respect to FIG. 4.

According to some exemplary embodiments, there is provided a communication system including a host computer. The host computer may comprise processing circuitry configured to provide user data, and a communication interface configured to forward the user data to a cellular network for transmission to a UE. The cellular network may comprise a base station having a radio interface and processing circuitry. The base station's processing circuitry may be configured to perform any step of the exemplary method 400 as describe with respect to FIG. 4.

According to some exemplary embodiments, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station. The UE may perform any step of the exemplary method 300 as describe with respect to FIG. 3.

According to some exemplary embodiments, there is provided a communication system including a host computer. The host computer may comprise processing circuitry configured to provide user data, and a communication interface configured to forward user data to a cellular network for transmission to a UE. The UE may comprise a radio interface and processing circuitry. The UE's processing circuitry may be configured to perform any step of the exemplary method 300 as describe with respect to FIG. 3.

According to some exemplary embodiments, there is provided a method implemented in a communication system which may include a host computer, a base station and a UE. The method may comprise, at the host computer, receiving user data transmitted to the base station from the UE which may perform any step of the exemplary method 300 as describe with respect to FIG. 3.

According to some exemplary embodiments, there is provided a communication system including a host computer. The host computer may comprise a communication interface configured to receive user data originating from a transmission from a UE to a base station. The UE may comprise a radio interface and processing circuitry. The UE's processing circuitry may be configured to perform any step of the exemplary method 300 as describe with respect to FIG. 3.

According to some exemplary embodiments, there is provided a method implemented in a communication system which may include a host computer, a base station and a UE. The method may comprise, at the host computer, receiving, from the base station, user data originating from a transmission which the base station has received from the UE. The base station may perform any step of the exemplary method 400 as describe with respect to FIG. 4.

According to some exemplary embodiments, there is provided a communication system which may include a host computer. The host computer may comprise a communication interface configured to receive user data originating from a transmission from a UE to a base station. The base station may comprise a radio interface and processing circuitry. The base station's processing circuitry may be configured to perform any step of the exemplary method 400 as describe with respect to FIG. 4.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1. A method performed by a terminal device, comprising:
receiving a channel state information request from a network node; and
transmitting a channel state information report to the network node in a random access procedure, in response to the channel state information request.

2. The method according to claim 1, wherein the random access procedure is a two-step random access procedure.

3. The method according to claim 1, wherein the channel state information request is indicated by at least one of:
system information;
radio resource control signaling;
downlink control information;
a response message to physical random access channel transmission in the random access procedure;
a response message to physical uplink shared channel transmission in the random access procedure;
scheduling signaling for uplink transmission in the random access procedure;
a physical downlink control channel order; and
a handover command.

4. The method according to claim 3, wherein the scheduling signaling for uplink transmission in the random access procedure comprises at least one of:
an uplink grant for the transmission of the channel state information report;
an uplink grant for physical uplink shared channel transmission; and
an indication of changing from the random access procedure to another random access procedure.

5. The method according to claim 2, wherein the channel state information request is indicated by an uplink grant in a message B received by the terminal device from the network node in the two-step random access procedure.

6. The method according to claim 1, wherein the channel state information report is based at least in part on measurement by the terminal device on one or more of:
at least a specific reference signal indicated to the terminal device by the network node;
at least a synchronization signal and physical broadcast channel block; and
at least a channel state information-reference signal.

7. The method according to claim 1, wherein the channel state information report is configured according to at least one of:
a handover command from the network node; and
a predefined channel state information framework.

8. The method according to claim 1, wherein the channel state information report indicates at least one of:
reference signal received power;
reference signal received quality;
signal to interference plus noise ratio; and
channel quality information.

9. The method according to claim 1, wherein the transmitting of the channel state information report is performed on at least one of:
uplink resource scheduled by the network node; and
uplink resource reserved for physical uplink shared channel transmission.

10. The method according to claim 9, wherein the uplink resource scheduled by the network node comprises at least one of:
uplink resource indicated by a response message to physical uplink shared channel transmission; and
uplink resource indicated by downlink control information.

11. The method according to claim 1, wherein the transmitting of the channel state information report comprises at least one of:
transmitting the channel state information report multiplexed with physical uplink shared channel; and
transmitting the channel state information report as a part of physical uplink shared channel.

12. A terminal device, comprising:
one or more processors; and
one or more memories comprising computer program codes which,
when executed by the one or more processors, cause the terminal device to:
receive a channel state information request from a network node; and
transmit a channel state information report to the network node in a random access procedure, in response to the channel state information request.

13.-14. (canceled)

15. A method performed by a network node, comprising:
transmitting a channel state information request to a terminal device; and
receiving a channel state information report in response to the channel state information request, from the terminal device in a random access procedure.

16. The method according to claim 15, wherein the random access procedure is a two-step random access procedure.

17. The method according to claim 15, wherein the channel state information request is indicated by at least one of:
system information;
radio resource control signaling;
downlink control information;
a response message to physical random access channel transmission in the random access procedure;
a response message to physical uplink shared channel transmission in the random access procedure;
scheduling signaling for uplink transmission in the random access procedure;
a physical downlink control channel order; and
a handover command.

18. The method according to claim 17, wherein the scheduling signaling for uplink transmission in the random access procedure comprises at least one of:
an uplink grant for transmission of the channel state information report;
an uplink grant for physical uplink shared channel transmission; and
an indication of changing from the random access procedure to another random access procedure.

19. The method according to claim 16, wherein the channel state information request is indicated by an uplink grant in a message B transmitted to the terminal device by the network node in the two-step random access procedure.

20. The method according to claim 15, wherein the channel state information report is based at least in part on measurement by the terminal device on one or more of:
at least a specific reference signal indicated to the terminal device by the network node;
at least a synchronization signal and physical broadcast channel block; and
at least a channel state information-reference signal.

21. The method according to claim 15, wherein the channel state information report is configured according to at least one of:
a handover command from the network node; and
a predefined channel state information framework.

22-25. (canceled)

26. A network node, comprising:
one or more processors; and
one or more memories comprising computer program codes which,
when executed by the one or more processors, cause the network node to:
transmit a channel state information request to a terminal device; and
receive a channel state information report in response to the channel state information request, from the terminal device in a random access procedure.

27-28. (canceled)
